(19) United States
(12) Patent Application Publication
(10) Pub. No.: US 2024/0101124 A1
(43) Pub. Date: Mar. 28, 2024

(54) DRIVER DISTRACTED STATE DETERMINATION APPARATUS, CIRCUIT AND COMPUTER PROGRAM THEREFOR

(71) Applicant: Mazda Motor Corporation, Hiroshima (JP)

(72) Inventors: Koji IWASE, Aki-gun (JP); Yohei IWASHITA, Aki-gun (JP)

(73) Assignee: Mazda Motor Corporation, Hiroshima (JP)

(21) Appl. No.: 18/125,761

(22) Filed: Mar. 24, 2023

(30) Foreign Application Priority Data
Sep. 22, 2022 (JP) 2022-151226

(51) Int. Cl. B60W 40/09; B60W 50/14

(52) U.S. Cl. CPC B60W 40/09; B60W 50/14; B60W 2540/225; B60W 2540/229; B60W 2540/30; B60W 2554/4041

(57) ABSTRACT

A controller acquires a driving load score based on the travel environment information, acquires a distracted state occurrence score based on the driving load score and an elapsed time with the driving load score, acquires a search behavior score based on the travel environment information and the driver's sightline when the distracted state occurrence score is equal to or higher than a specified value, acquires a distracted state level of the driver based on the search behavior score and an elapsed time with the search behavior score, and determines that the driver is in the distracted state when the distracted state level is equal to or higher than a threshold and the search behavior score is increased in response to an increase in the driving load score.

### CROSS-REFERENCE TO RELATED APPLICATION

The present application claims priority to Japanese Patent Application No. 2022-151226 filed in the Japanese Patent Office on Sep. 22, 2022, the entire contents of which being incorporated herein by reference.

### TECHNICAL FIELD

The present disclosure relates to a driver state determination apparatus that determines a state of a driver who drives a vehicle.

### BACKGROUND ART

One of main causes of traffic accidents is a state where a driver lacks concentration on driving, i.e., a so-called distracted state. Conventionally, as techniques for detecting the distracted state, the following techniques have been proposed: a technique of focusing on change amounts of the driver's face direction and sightline direction (for example, see Patent document 1), a technique of focusing on the number of times of visual recognition behavior (for example, see Patent document 2), a technique of focusing on the driver's degree of concentration and degree of comfort on driving (for example, see Patent document 3), and the like.

### PRIOR ART DOCUMENTS

### Patent Documents

[Patent document 1] JP-A-2020-086907
[Patent document 2] JP-A-2019-121227
[Patent document 3] JP-B-6380464

### SUMMARY

### Problems to be Solved

However, in the related art as described above, even in the case where, due to a mild disease, aging, or the like, the change amounts of the driver's face direction and sightline direction or the number of times of the visual recognition behavior is reduced, or the driver's degree of concentration on driving is reduced, the driver may be determined to be in the distracted state. In other words, in the related art, the driver's distracted state cannot be distinguished from another abnormal state of the driver, such as the disease, and accurately determine the driver's distracted state.

Embodiments are directed solving this and other problems and therefore has a purpose of providing a driver state determination apparatus capable of distinguishing a driver's distracted state from another abnormal state of the driver, such as a disease, and promptly and accurately determining the driver's distracted state.

### Means for Solving the Problems

In order to solve the above-described and other problems, a driver state determination apparatus that determines a state of a driver who drives a vehicle, may include: a travel environment information acquisition device that acquires travel environment information of the vehicle; a sightline detector that detects the driver's sightline; and a controller configured to determine the driver's state based on the travel environment information and the driver's sightline. The controller is configured to: acquire a driving load score based on the travel environment information, the driving load score representing a magnitude of a load on the driver during driving of the vehicle; acquire a distracted state occurrence score based on the driving load score and an elapsed time with the driving load score, the distracted state occurrence score representing a degree of likelihood that the driver is brought into a distracted state; acquire a search behavior score based on the travel environment information and the driver's sightline in the case where the distracted state occurrence score is equal to or higher than a specified value, the search behavior score representing a degree of normality of search behavior by the driver's visual perception; acquire a distracted state level of the driver based on the search behavior score and an elapsed time with the search behavior score; and determine that the driver is in the distracted state in the case where the distracted state level is equal to or higher than a threshold and where the search behavior score is increased in response to an increase in the driving load score.

Accordingly, the controller acquires the distracted state occurrence score, which represents the degree of likelihood that the driver is brought into the distracted state, based on the driving load score and the elapsed time with the driving load score. Thus, in a situation where the driver is likely to be in the distracted state according to the driving load, whether the driver is in the distracted state may be promptly determined. In addition, in the case where the distracted state occurrence score is equal to or higher than the specified value, the controller acquires the search behavior score, which represents the degree of normality of the search behavior by the driver's visual perception, based the travel environment information and the driver's sightline. Then, the controller acquires the distracted state level of the driver based the search behavior score and the elapsed time with the search behavior score. Thus, the distracted state may be promptly determined based on the degree of normality of the search behavior, which is easily affected by the distracted state. Furthermore, in the case where the distracted state level is equal to or higher than the threshold, and the search behavior score is increased in response to the increase in the driving load score, the controller determines that the driver is in the distracted state. Thus, the distracted state may be accurately determined by focusing on a change that appears characteristically at the time when the driver is in the distracted state but not in an abnormal state (that the search behavior becomes normal when the driving load is increased and thus a behavior request for the driver is enhanced) and distinguishing such a change from a change in the abnormal state. In this way, the driver's distracted state may be distinguished from another abnormal state, such as a disease, and promptly and accurately determine the driver's distracted state.

The controller may be configured to: acquire a cognitive load score, which represents a magnitude of a load on the driver to recognize an object in travel environment of the vehicle, and an operation load score, which represents a magnitude of a load to operate the vehicle in the travel environment, based on the travel environment information; and acquire the driving load score on the basis of the cognitive load score and the operation load score.

Accordingly, the controller acquires the driving load score based on the cognitive load score and the operation load score. Thus, a magnitude of the driving load may be evaluated in consideration of a cognitive load and an operation load, which affect likelihood of occurrence of the distracted state. Thus, a more accurate distracted state occurrence score may be determined.

The controller may be configured to: acquire a surprise value, which represents a distance between a predicted position and an actual position of the object that attracts the driver's attention, based on the travel environment information; and calculate the search behavior score such that the search behavior score is increased as a tendency of the driver's sightline to be directed to the object with the relatively high surprise value is increased.

Accordingly, the controller calculates the driver's search behavior score based on a behavioral principle of a person that the driver in a normal state directs his/her sightline to the object with the relatively high surprise value. Thus, the search behavior score, to which the driver's state is further accurately reflected, may be acquired.

### Advantages

According to the driver state determination apparatus described herein, the driver's distracted state may be distinguished from the other abnormal state, such as the disease, and promptly and accurately determine the driver's distracted state.

### BRIEF DESCRIPTION OF THE DRAWINGS

FIG. 1 is an explanatory view of a vehicle on which a driver state determination apparatus according to an embodiment.

FIG. 2 is a block diagram of the driver state determination apparatus according to the embodiment.

FIG. 3 is a flowchart of driver state determination processing according to the embodiment.

FIG. 4 is an example of a cognitive load score table according to the embodiment.

FIG. 5 is an example of an operation load score table according to the embodiment.

FIG. 6 is an example of a driving load score map according to the embodiment.

FIG. 7 is an example of a distracted state occurrence score map according to the embodiment.

FIG. 8 is an example of a distracted state level map according to the embodiment.

FIG. 9 is a graph illustrating a change in a search behavior score at the time with a high driving load according to the embodiment.

### DETAILED DESCRIPTION

A description will hereinafter be made on a driver state determination apparatus according to an embodiment with reference to the accompanying drawings.

[System Configuration]

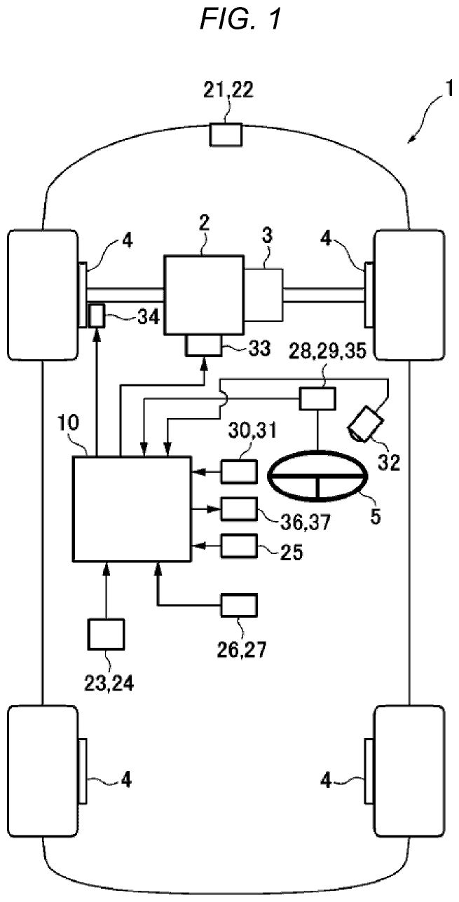

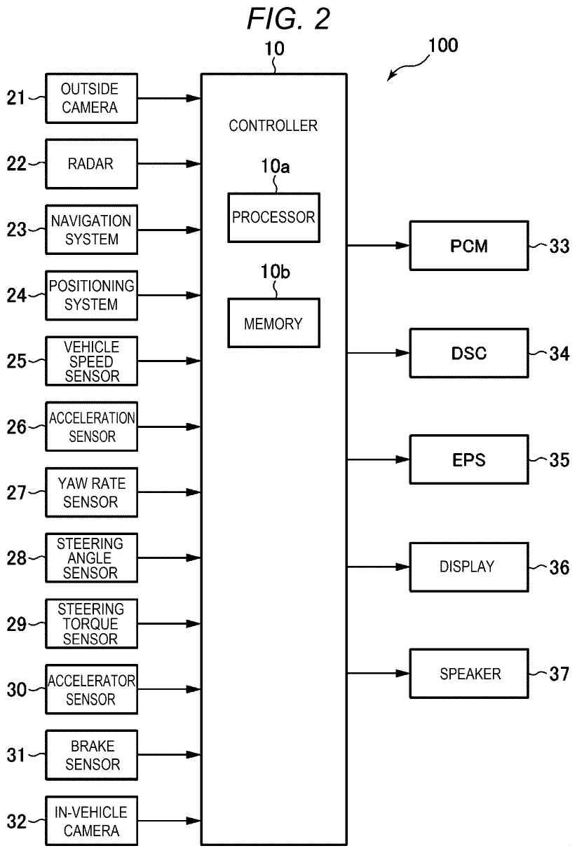

First, a description will be made on a configuration of the driver state determination apparatus according to this embodiment with reference to FIG. 1 and FIG. 2. FIG. 1 is an explanatory view of a vehicle on which the driver state determination apparatus is mounted, and FIG. 2 is a block diagram of the driver state determination apparatus.

A vehicle 1 according to this embodiment includes: drive power sources 2 such as an engine and an electric motor that output drive power; a transmission 3 that transmits the drive power output from the drive power source 2 to drive wheels; a brake 4 that applies a braking force to the vehicle 1; and a steering device 5 for steering the vehicle 1.

A driver state determination apparatus 100 is configured to determine a state of a driver of the vehicle 1 and to execute control of the vehicle 1 and driving assistance control when necessary. As illustrated in FIG. 2, the driver state determination apparatus 100 has a controller 10, plural sensors, plural control systems, and plural information output devices.

More specifically, the plural sensors include an outside camera 21 and a radar 22 for acquiring travel environment information of the vehicle 1 as well as a navigation system 23 and a positioning system 24 for detecting a position of the vehicle 1. The plural sensors also include a vehicle speed sensor 25, an acceleration sensor 26, a yaw rate sensor 27, a steering angle sensor 28, a steering torque sensor 29, an accelerator sensor 30, and a brake sensor 31 for detecting behavior of the vehicle 1 and the driver's driving operation. The plural sensors further include an in-vehicle camera 32 for detecting the driver's sightline. The plural control systems include: a powertrain control module (PCM) 33 that controls the drive power source 2 and the transmission 3; a dynamic stability control system (DSC) 34 that controls the drive power source 2 and the brake 4; and an electric power steering system (EPS) 35 that controls the steering device 5. The plural information output devices include a display 36 that outputs image information and a speaker 37 that outputs voice information.

In addition, as other sensors, a peripheral sonar system that measures a distance and a position of a peripheral structure relative to the vehicle 1, a corner radar that measures approach of the peripheral structure at each of four corner sections of the vehicle 1, and various sensors (for example, a heart rate sensor, an electrocardiogram sensor, a steering wheel grip force sensor, and the like) that detect the driver's state may be included.

The controller 10 executes various arithmetic operations based on signals received from the plural sensors, transmits, to the PCM 33, the DSC 34, and the EPS 35, a control signal for appropriately actuating the drive power source 2, the transmission 3, the brake 4, and the steering device 5, and transmits, to the display 36 and the speaker 37, a control signal for outputting desired information. The controller 10 is a computer that includes one or more processors 10a (typically, a CPU), memory 10b (ROM, RAM, and the like, e.g., a non-transitory storage device) that stores various programs and data, an input/output device, and the like. As used herein ‘computer’ refers to circuitry that may be configured via the execution of computer readable instructions, and the circuitry may include one or more local processors 10a (e.g., CPU's), and/or one or more remote processors, such as a cloud computing resource, or any combination thereof.

The outside camera 21 captures an image, e.g., a visible image, an infrared image, or the like, around the vehicle 1 and outputs image data. The controller 10 identifies an object (for example, a preceding vehicle, a parked vehicle, a pedestrian, a travel road, a lane marking (a lane divider, a white line, or a yellow line), a traffic signal, a traffic sign, a stop line, an intersection, an obstacle, or the like) based on the image data received from the outside camera 21. The outside camera 21 corresponds to an example of the “travel environment information acquisition device” in the disclosure.

The radar 22 measures a position and a speed of the object (particularly, the preceding vehicle, the parked vehicle, the pedestrian, a dropped object on the travel road, or the like). For example, a millimeter-wave radar can be used as the radar 22. The radar 22 transmits a radio wave in an advancing direction of the vehicle 1, and receives a reflected wave generated when the object reflects the transmitted wave. Then, based on the transmitted wave and the received wave, the radar 22 measures a distance between the vehicle 1 and the object (for example, an inter-vehicular distance) and a relative speed of the object to the vehicle 1. In this embodiment, instead of the radar 22, a laser radar, an ultrasonic sensor, or the like may be used to measure the distance from and the relative speed of the object. Alternatively, the plural sensors may be used to constitute a position and speed measuring device. The radar 22 corresponds to an example of the “travel environment information acquisition device” in the disclosure.

The navigation system 23 stores map information therein and can provide the map information to the controller 10. Based on the map information and current vehicle position information, the controller 10 identifies a road, the intersection, the traffic signal, a building, or the like that exists around (particularly, in the advancing direction of) the vehicle 1. The map information may be stored in the controller 10. The positioning system 24 is a GPS system and/or a gyroscopic system, and detects the position of the vehicle 1 (the current vehicle position information). Each of the navigation system 23 and the positioning system 24 also corresponds to an example of the “travel environment information acquisition device” in the disclosure.

The vehicle speed sensor 25 detects a speed of the vehicle 1 based on a rotational speed of the wheel or a driveshaft, for example. The acceleration sensor 26 detects acceleration of the vehicle 1. This acceleration includes acceleration in a front-rear direction of the vehicle 1 and acceleration in a lateral direction (that is, lateral acceleration) thereof. In the present specification, the acceleration includes not only a change rate of the speed in a speed increasing direction but also a change rate of the speed in a speed reducing direction (that is, deceleration).

The yaw rate sensor 27 detects a yaw rate of the vehicle 1. The steering angle sensor 28 detects a rotation angle (a steering angle) of the steering wheel of the steering device 5. The steering torque sensor 29 detects torque (steering torque) applied to a steering shaft via the steering wheel. The accelerator sensor 30 detects a depression amount of an accelerator pedal. The brake sensor 31 detects a depression amount of a brake pedal.

The in-vehicle camera 32 captures an image of the driver and outputs image data. The controller 10 detects the driver's sightline direction based on the image data received from the in-vehicle camera 32. The in-vehicle camera 32 corresponds to an example of the “sightline detector” in the disclosure.

The PCM 33 controls the drive power source 2 of the vehicle 1 to adjust the drive power of the vehicle 1. For example, the PCM 33 controls an ignition plug of the engine, a fuel injection valve, a throttle valve, a variable valve mechanism, the transmission 3, an inverter that supplies electric power to the electric motor, and the like. When the vehicle 1 has to be accelerated or decelerated, the controller 10 transmits the control signal to the PCM 33 so as to adjust the drive power.

The DSC 34 controls the drive power source 2 and the brakes 4 of the vehicle 1 and thereby executes deceleration control and posture control of the vehicle 1. For example, the DSC 34 controls a hydraulic pump, a valve unit, and the like of the brake 4, and controls the drive power source 2 via the PCM 33. When it is necessary to execute the deceleration control or the posture control of the vehicle 1, the controller 10 transmits the control signal to the DSC 34 so as to adjust the drive power or generate the braking force.

The EPS 35 controls the steering device 5 of the vehicle 1. For example, the EPS 35 controls the electric motor, which applies the torque to the steering shaft of the steering device 5, and the like. When the advancing direction of the vehicle 1 has to be changed, the controller 10 transmits the control signal to the EPS 35 so as to change a steering direction.

The display 36 is provided in front of the driver in a cabin and displays the image information to the driver. As the display 36, for example, a liquid-crystal display or a head-up display is used. The speaker 37 is installed in the cabin and outputs various types of the voice information.

[Driver State Determination Processing]

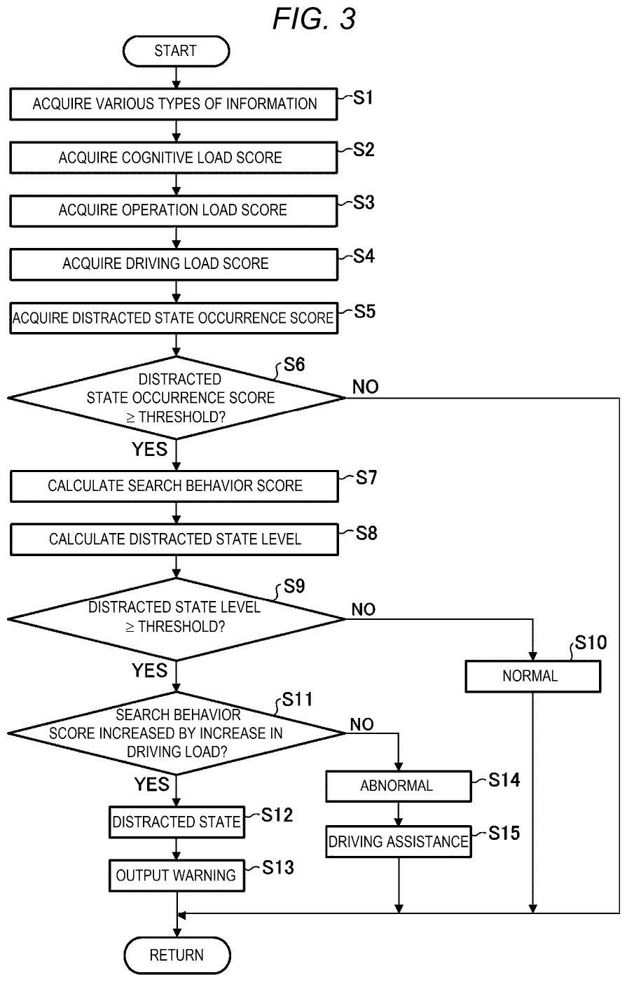

Next, a description will be made on a flow of driver state determination processing by the driver state determination apparatus 100 in this embodiment with reference to FIG. 3. FIG. 3 is a flowchart of the driver state determination processing.

The driver state determination processing is initiated when a power supply of the vehicle 1 is turned on. Then, the driver state determination processing is repeatedly executed by the controller 10 in a specified cycle (for example, every 0.05 to 0.2 second).

When the driver state determination processing is initiated, first, the controller 10 acquires various types of information including the travel environment information and the driver's sightline based on the signals that are received from the sensors including the outside camera 21, the radar 22, the navigation system 23, the positioning system 24, and the in-vehicle camera 32 (step S1).

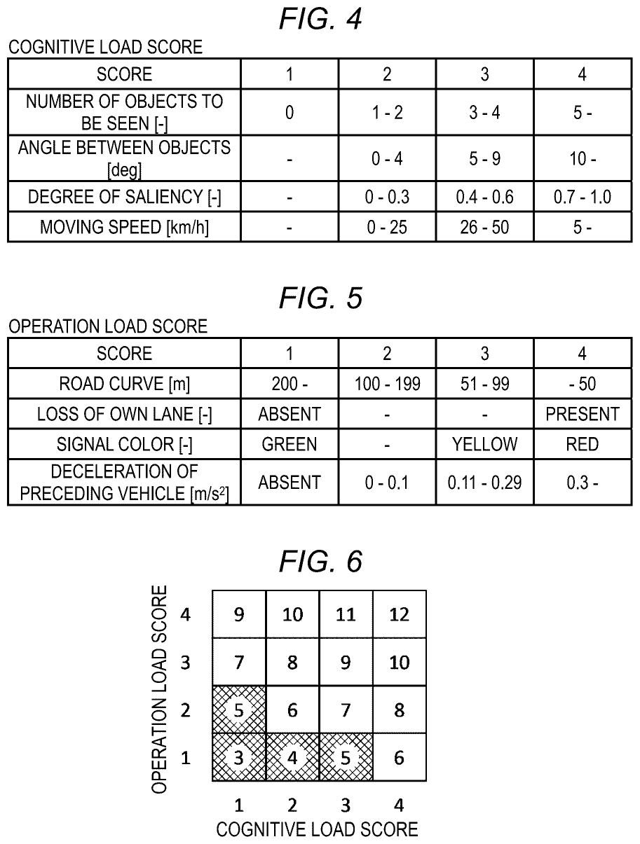

Next, based on the travel environment information acquired in step S1, the controller 10 acquires a cognitive load score that represents a magnitude of a load for the driver to recognize the object in the travel environment of the vehicle 1 (step S2). More specifically, a cognitive load score table is stored in the memory 10b in advance. In the cognitive load score table, factors, each of which affects the driver's cognitive load, are each associated with scores, each of which represents a magnitude of the cognitive load corresponding to each of the factors, in advance. FIG. 4 is an example of a cognitive load score table. In the example illustrated in FIG. 4, the number of the objects to be seen by the driver during driving, an angle between the objects, prominence (a degree of saliency) of the object, and a moving speed of the object are set as the factors (cognitive load factors), each affect the cognitive load. As can be seen in FIG. 4, the cognitive load score increases as (1) the number of the objects to be seen increases, (2) the angle between the objects increases, (3) the degree of saliency of the object increases, and/or (4) the moving speed of the object increases. The controller 10 acquires a value of each of the cognitive load factors based on the travel environment information acquired from the outside camera 21 and the radar 22. Then, the controller 10 calculates an average value of the cognitive load scores, each of which corresponds to the value of the respective cognitive load factor, as the cognitive load score in the current travel environment.

Next, based on the travel environment information acquired in step S1, the controller 10 acquires an operation load score that represents a magnitude of a load for the driver to operate the vehicle 1 in the travel environment of the vehicle 1 (step S3). More specifically, an operation load score table is stored in the memory 10b in advance. In the operation load score table, factors, each of which affects the driver's operation load, are each associated with scores, each of which represents a magnitude of the operation load corresponding to each of the factors, in advance. FIG. 5 is an example of the operation load score table. In the example illustrated in FIG. 5, a radius of curvature of a road curve, presence or absence of loss of an own lane, a signal color, and deceleration of the preceding vehicle are set as the factors (operation load factors), each of which affects the operation load. In addition, as may be seen in FIG. 5, the operation load score increases (1) as the radius of curvature decreases, (2) when the loss of the own lane is present is compared to a situation in which the loss of the own lane is absent, (3) based on a traffic signal color, in an order of green (go), yellow (caution), and red (stop), and/or (4) as the deceleration of the preceding vehicle increases. The controller 10 acquires a value of each of the operation load factors based on the travel environment information acquired from the outside camera 21, the radar 22, the navigation system 23, and the positioning system 24. Then, the controller 10 calculates an average value of the operation load scores, each of which corresponds to the value of the respective operation load factor, as the operation load score in the current travel environment.

Next, the controller 10 calculates a driving load score based on the cognitive load score acquired in step S2 and the operation load score acquired in step S3 (step S4). More specifically, a driving load score map in which a driving load score is set is stored in the memory 10b in advance. The driving load score corresponds to the cognitive load score and the operation load score. FIG. 6 is an example of the driving load score map. As may be seen in the example illustrated in FIG. 6, the driving load score increases as the cognitive load score increases and/or as the operation load score increases. For example, in the case where the cognitive load score is 2 and the operation load score is 1, the driving load score is 4. In the case where the cognitive load score is 4 and the operation load score is 3, the driving load score is 10. The controller 10 refers to this driving load score map and acquires the driving load score that corresponds to the cognitive load score acquired in step S2 and the operation load score acquired in step S3.

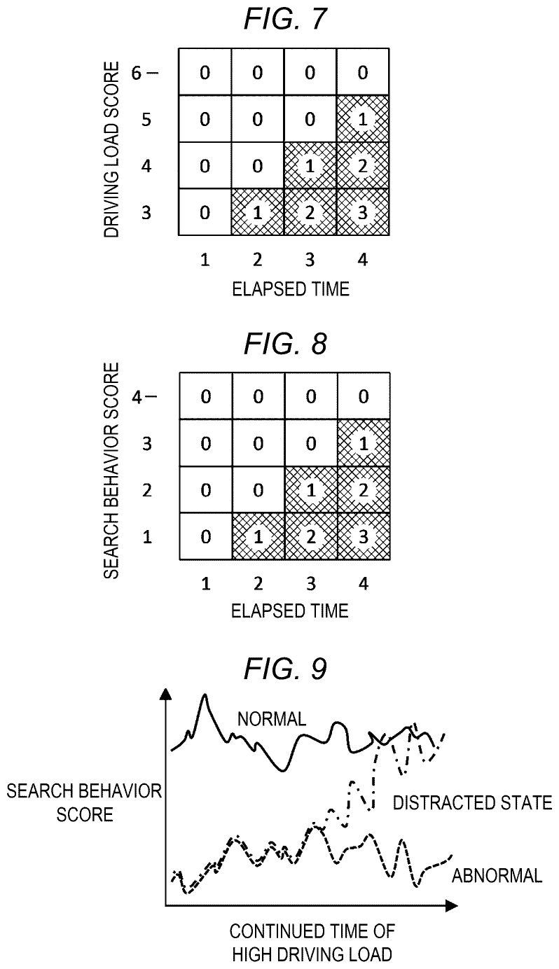

Next, based on the driving load score acquired in step S4 and an elapsed time with the driving load score, the controller 10 acquires a distracted state occurrence score representing a degree of likelihood that the driver is brought into the distracted state (step S5). More specifically, a distracted state occurrence score map in which a distracted state occurrence score is set is stored in the memory 10b in advance. The distracted state occurrence score corresponds to the driving load score and the elapsed time with the driving load score. FIG. 7 is an example of a distracted state occurrence score map. As may be seen in FIG. 7, the distracted state occurrence score increases as the driving load score decreases and/or as the elapsed time increases. This is because, in the case where the low driving load continues for a long time, the driver is more likely to be brought into the distracted state. Every time the controller 10 acquires the driving load score in the driver state determination processing, which is executed repeatedly, the controller 10 stores the driving load score and time of acquisition. Then, after acquiring the driving load score in step S4, the controller 10 refers to the distracted state occurrence score map and acquires the distracted state occurrence score that corresponds to the driving load score acquired in step S4 and a time in which the driving load score remains the same (the elapsed time).

Next, the controller 10 determines whether the distracted state occurrence score acquired in step S5 is equal to or higher than a specified threshold (step S6). For example, in the case where the distracted state occurrence score map illustrated in FIG. 7 is used, the threshold is set to 1. As a result, if the distracted state occurrence score is not equal to or higher than the threshold (is lower than the threshold) (step S6: NO), the controller 10 determines that the driver is unlikely to be in the distracted state, and terminates the driver state determination processing.

On the other hand, if the distracted state occurrence score is equal to or higher than the threshold (step S6: YES), the controller 10 calculates a search behavior score based on the travel environment information and the driver's sightline that are acquired in step S1 (step S7). The search behavior score represents a degree of normality of search behavior by the driver's visual perception.

More specifically, based on the signals received from the outside camera 21 and the radar 22, the controller 10 identifies a position of a visual recognition required object that should be recognized visually by the driver (the object that attracts top-down attention of the driver). The controller 10 also identifies distribution of the saliency (ease of attracting bottom-up attention of the driver) in front of the vehicle 1 based on the signal received from the outside camera 21. Then, the controller 10 calculates a predicted position (probability distribution) after a specified time of each of the identified position of the visual recognition required object and the identified saliency distribution by a known method.

Next, the controller 10 acquires the actual position of the visual recognition required object and the actual saliency distribution after a specified time, and calculates a distance (for example, expressed by the Kullback-Leibler divergence) from the predicted position (the probability distribution) of each of the position of the visual recognition required object and the saliency distribution, which have been calculated earlier. The distance calculated herein is set as a surprise value for respective one of the visual recognition required object and the saliency distribution. In other words, as the distance between the predicted position and the actual position of each of the position of the visual recognition required object and the saliency distribution is increased, the surprise to the driver is increased. Thus, the driver in the normal state is highly likely to direct his/her sightline.

Then, the controller 10 calculates the search behavior score from the calculated surprise value such that the search behavior score is increased as a tendency of the driver's sightline to be directed at the object with the relatively high surprise value is increased. For example, the controller 10 generates a receiver operating characteristic (ROC) curve by plotting a probability that the surprise value in the driver's sightline direction exceeds the specified threshold and a probability that the surprise value at a random point in front of the vehicle 1 exceeds the specified threshold while changing the specified threshold. Then, the controller 10 sets the search behavior score by multiplying an area under the curve (AUC) of the ROC curve by a specified coefficient. In this case, as the tendency of the driver's sightline to be directed to the object with the high surprise value is increased, the AUC is increased, and the search behavior score is increased.

Next, the controller 10 calculates the driver's distracted state level based on the search behavior score and an elapsed time with the search behavior score (step S8). More specifically, a distracted state level map in which a distracted state level is set is stored in the memory 10b in advance. The distracted state level corresponds to the search behavior score and the elapsed time with the search behavior score. FIG. 8 is an example of the distracted state level map. As can be seen in FIG. 8, the distracted state level increases as the search behavior score decreases and/or as the elapsed time is increases. This is because, when a low state of the search behavior score, that is, a low state of the tendency of the driver's sightline to be directed to the object with the high surprise value continues for a long time, the driver is highly likely to be in the distracted state. Every time the controller 10 calculates the search behavior score in the driver state determination processing, which is executed repeatedly, the controller 10 stores the search behavior score and time of calculation. Then, after calculating the search behavior score in step S7, the controller 10 refers to the distracted state level map and acquires the distracted state level that corresponds to the search behavior score calculated in step S7 and a time in which the search behavior score remains the same (the elapsed time).

Next, the controller 10 determines whether the distracted state level calculated in step S8 is equal to or higher than a specified threshold (step S9). For example, in the case where the distracted state level map illustrated in FIG. 8 is used, the threshold is set to 1. As a result, if the distracted state level is not equal to or higher than the threshold (is lower than the threshold) (step S9: NO), the controller 10 determines that the driver is in the normal state (step S10), and terminates the driver state determination processing.

On the other hand, if the distracted state level is equal to or higher than the threshold (step S9: YES), the controller 10 determines whether the search behavior score has been increased in response to the increase in the driving load score (step S11). More specifically, every time the controller 10 acquires the driving load score and the search behavior score in the driver state determination processing, which is executed repeatedly, the controller 10 stores the driving load score, the search behavior score, and the time of acquisition of each thereof. Then, the controller 10 identifies, in time-series data, a change in the search behavior score in a period in which the increased state of the driving load score is maintained. FIG. 9 is a graph illustrating the change in the search behavior score at the time with the high driving load according to this embodiment. As indicated by a one-dot chain line in FIG. 9, in the case where the search behavior score increases while the increased state of the driving load score is maintained, the controller 10 determines that the search behavior score has been increased in response to the increase in the driving load score.

That the search behavior score is increased in response to the increase in the driving load score means that, when the driving load is increased and a behavior request for the driver is enhanced, the driver can take the normal search behavior in response thereto. That is, a reason why the search behavior score is low and the distracted state level is high prior the increase in the driving load is not because the driver suffers from abnormality, such as disease, but because the driver is in the distracted state. Thus, if the search behavior score is increased in response to the increase in the driving load score (step S11: YES), the controller 10 determines that the driver is in the distracted state (step S12).

Next, the controller 10 transmits the control signal to the display 36 and the speaker 37, and causes one or both of the display 36 and the speaker 37 to output a warning for notifying the driver that the driver is in the distracted state (step S13). At this time, the controller 10 may cause the display 36 and the speaker 37 to respectively output the image information and the voice information (sightline guidance information) for guiding the driver's sightline to the visual recognition required object not visually recognized by the driver. After step S13, the controller 10 terminates the driver state determination processing.

Meanwhile, as indicated by a dotted line in the example illustrated in FIG. 9, if the search behavior score has not been increased in response to the increase in the driving load score (step S11: NO), it means that, even when the behavior request for the driver is enhanced due to the increased driving load, the driver cannot take the normal search behavior in response thereto. That is, it is considered that the reason why the search behavior score is low and the distracted state level is high prior the increase in the driving load is because the driver suffers from the abnormality, such as disease. Thus, the controller 10 determines that the driver is in an abnormal state (step S14).

In this case, the controller 10 transmits, to the PCM 33, the DSC 34, and the EPS 35, the control signal for appropriately actuating the drive power source 2, the transmission 3, the brake 4, and the steering device 5, and executes driving assistance control of the vehicle 1 such that the vehicle 1 is safely stopped on a road shoulder, for example (step S15). In addition, the controller 10 may transmit the control signal at least one of to the display 36 and the speaker 37 to cause the display 36 and the speaker 37 to output the warning. After step S15, the controller 10 terminates the driver state determination processing.

[Operational Effects]

Next, a description will be made on operational effects of the driver state determination apparatus 100 in the above-described embodiment.

The controller 10 acquires the distracted state occurrence score, which represents the degree of likelihood that the driver is brought into the distracted state, based on the driving load score and the elapsed time with the driving load score. Thus, in a situation where the driver is likely to be in the distracted state according to the driving load, whether the driver is in the distracted state may be promptly determined. In addition, in the case where the distracted state occurrence score is equal to or higher than the specified value, the controller 10 acquires the search behavior score, which represents the degree of normality of the search behavior by the driver's visual perception, based on the travel environment information and the driver's sightline. Then, the controller 10 acquires the distracted state level of the driver based on the search behavior score and the elapsed time with the search behavior score. Thus, the distracted state may be promptly determined based on the degree of normality of the search behavior, which is easily affected by the distracted state.

Furthermore, in the case where the distracted state level is equal to or higher than the threshold, and the search behavior score is increased in response to the increase in the driving load score, the controller 10 determines that the driver is in the distracted state. Thus, the distracted state may be accurately determined by focusing on the change that appears characteristically at the time when the driver is in the distracted state but not in the abnormal state (that the search behavior becomes normal when the driving load is increased and thus the behavior request for the driver is enhanced) and distinguishing such a change from the change in the abnormal state. In this way, the driver's distracted state may be distinguished from another abnormal state, such as the disease, and promptly and accurately determine the driver's distracted state.

The controller 10 acquires the driving load score based on the cognitive load score and the operation load score. Thus, a magnitude of the driving load may be evaluated in consideration of the cognitive load and the operation load, which affect likelihood of the occurrence of the distracted state. Thus, the further accurate distracted state occurrence score may be acquired.

The controller 10 acquires the surprise value based on the travel environment information. Then, the controller 10 calculates the search behavior score such that the search behavior score is increased as the tendency of the driver's sightline to be directed to the object with the relatively high surprise value is increased. In this way, the driver's search behavior score is calculated based on a behavioral principle of a person that the driver in the normal state directs his/her sightline to the object with the relatively high surprise value. Thus, the search behavior score, to which the driver's state is further accurately reflected, may be acquired.

No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure. The scope of the invention is indicated by the appended claims, rather than the foregoing description.

### DESCRIPTION OF REFERENCE SIGNS AND NUMERALS

1 Vehicle
10 Controller
100 Driver state determination apparatus
21 Outside camera
22 Radar
23 Navigation system
24 Positioning system
25 Vehicle speed sensor
26 Acceleration sensor
27 Yaw rate sensor
28 Steering angle sensor
29 Steering torque sensor
30 Accelerator sensor
31 Brake sensor
32 In-vehicle camera
36 Display
37 Speaker

1. A driver distracted state determination apparatus for determining a distracted state of a driver who drives a vehicle, the driver state determination apparatus comprising:
a travel environment information acquisition sensor that acquires travel environment information of the vehicle;
a sightline detector that detects the driver's sightline; and
a controller configured to determine the driver's state based on the travel environment information and the driver's sightline, wherein
the controller is configured to:
acquire a driving load score based on the travel environment information, the driving load score representing a magnitude of a load on the driver during driving of the vehicle;
acquire a distracted state occurrence score based on the driving load score and an elapsed time with the driving load score, the distracted state occurrence score representing a degree of likelihood that the driver is brought into a distracted state;
acquire a search behavior score based on the travel environment information and the driver's sightline in the case where the distracted state occurrence score is equal to or higher than a specified value, the search behavior score representing a degree of normality of search behavior by the driver's visual perception;
acquire a distracted state level of the driver based on the search behavior score and an elapsed time with the search behavior score; and
determine that the driver is in the distracted state in the case where the distracted state level is equal to or higher than a threshold and where the search behavior score is increased in response to an increase in the driving load score.

2. The driver distracted state determination apparatus according to claim 1, wherein
the controller is configured to
acquire a cognitive load score and an operation load score based on the travel environment information and acquire the driving load score based on the cognitive load score and the operation load score, the cognitive load score representing a magnitude of a load on the driver to recognize an object in travel environment of the vehicle, and the operation load score representing a magnitude of a load to operate the vehicle in the travel environment.

3. The driver distracted state determination apparatus according to claim 2, wherein
the controller is configured to
acquire a surprise value based on the travel environment information, and calculate the search behavior score such that the search behavior score is increased as a tendency of the driver's sightline to be directed to the object with the relatively high surprise value is increased, the surprise value representing a distance between a predicted position and an actual position of the object that attracts the driver's attention.

4. The driver distracted state determination apparatus according to claim 1, wherein
the controller is configured to
acquire a surprise value based on the travel environment information, and calculate the search behavior score such that the search behavior score is increased as a tendency of the driver's sightline to be directed to the object with the relatively high surprise value is increased, the surprise value representing a distance between a predicted position and an actual position of the object that attracts the driver's attention.

5. The driver distracted state determination apparatus according to claim 1, wherein the controller is configured to determine that the driver is in an abnormal state in the case where the distracted state level is equal to or higher than a threshold and where the search behavior score is not increased in response to an increase in the driving load score.

6. The driver distracted state determination apparatus according to claim 5, wherein when the driver is in the abnormal state, the controller is configured to execute driving assistance.

7. The driver distracted state determination apparatus according to claim 1, wherein, when the driver is in the distracted state, the controller is configured to output a warning that the driver is in the distracted state.

8. A driver distracted state determination circuit for determining a distracted state of a driver who drives a vehicle, the driver state determination circuit being configured to:
acquire travel environment information of the vehicle;
acquire the driver's sightline;
acquire a driving load score based on the travel environment information, the driving load score representing a magnitude of a load on the driver during driving of the vehicle;
acquire a distracted state occurrence score based on the driving load score and an elapsed time with the driving load score, the distracted state occurrence score representing a degree of likelihood that the driver is brought into a distracted state;
acquire a search behavior score based on the travel environment information and the driver's sightline in the case where the distracted state occurrence score is equal to or higher than a specified value, the search behavior score representing a degree of normality of search behavior by the driver's visual perception;
acquire a distracted state level of the driver based on the search behavior score and an elapsed time with the search behavior score; and
determine that the driver is in the distracted state in the case where the distracted state level is equal to or higher than a threshold and where the search behavior score increases in response to an increase in the driving load score.

9. The driver distracted state determination circuit according to claim 8, the driver distracted state determination circuit is configured to:
acquire a cognitive load score and an operation load score based on the travel environment information; and
acquire the driving load score based on the cognitive load score and the operation load score, the cognitive load score representing a magnitude of a load on the driver to recognize an object in travel environment of the vehicle, and the operation load score representing a magnitude of a load to operate the vehicle in the travel environment.

10. The driver distracted state determination apparatus according to claim 9, the driver distracted state determination circuit is configured to:
acquire a surprise value based on the travel environment information; and
calculate the search behavior score such that the search behavior score is increased as a tendency of the driver's sightline to be directed to the object with the relatively high surprise value is increased, the surprise value representing a distance between a predicted position and an actual position of the object that attracts the driver's attention.

11. The driver distracted state determination circuit according to claim 8, wherein the driver distracted state determination circuit is configured to
acquire a surprise value based on the travel environment information; and
calculate the search behavior score such that the search behavior score is increased as a tendency of the driver's sightline to be directed to the object with the relatively high surprise value is increased, the surprise value representing a distance between a predicted position and an actual position of the object that attracts the driver's attention.

12. The driver distracted state determination circuit according to claim 8, wherein the controller is configured to determine that the driver is in an abnormal state in the case where the distracted state level is equal to or higher than a threshold and where the search behavior score is not increased in response to an increase in the driving load score.

13. The driver distracted state determination circuit according to claim 12, wherein when the driver is in the abnormal state, the driver distracted state determination circuit is configured to execute driving assistance.

14. The driver distracted state determination circuit according to claim 1, wherein when the driver is in the distracted state, the driver distracted state determination circuit is configured to output a warning that the driver is in the distracted state.

15. A non-transitory computer readable storage device having computer readable instructions that when executed by circuitry cause the circuitry to:
acquire travel environment information of a vehicle being driven by a driver;
acquire the driver's sightline;
acquire a driving load score based on the travel environment information, the driving load score representing a magnitude of a load on the driver during driving of the vehicle;
acquire a distracted state occurrence score based on the driving load score and an elapsed time with the driving load score, the distracted state occurrence score representing a degree of likelihood that the driver is brought into a distracted state;
acquire a search behavior score based on the travel environment information and the driver's sightline in the case where the distracted state occurrence score is equal to or higher than a specified value, the search behavior score representing a degree of normality of search behavior by the driver's visual perception;
acquire a distracted state level of the driver based on the search behavior score and an elapsed time with the search behavior score; and
determine that the driver is in the distracted state in the case where the distracted state level is equal to or higher than a threshold and where the search behavior score increases in response to an increase in the driving load score.
